(19) United States
(12) Patent Application Publication
(10) Pub. No.: US 2023/0053283 A1
(43) Pub. Date: Feb. 16, 2023

(54) PLANTER WITH NESTED STAND

(71) Applicant: THE HC COMPANIES, INC., Twinsburg, OH (US)

(72) Inventors: Drew Keeble, Cleveland, OH (US); Shinya Kumazawa, Toronto (CA)

(21) Appl. No.: 17/403,065

(22) Filed: Aug. 16, 2021

(51) Int. Cl. A01G 9/02

(52) U.S. Cl. CPC A01G 9/02

(57) ABSTRACT

A planter and stand assembly includes a stand having a sidewall surrounding a hollow region and tapered between a first end of the sidewall and a second end of the sidewall, the stand having a first opening at the first end and a second opening at the second end, the first opening larger than the second opening, and the stand having a first stand support surface at the first end and a second stand support surface at the second end; and a planter having a first planter support surface sized to radially overlap with the first stand support surface and rest thereon in a first configuration in which the first stand support surface faces upward and a second planter support surface sized to radially overlap with the second stand support surface and rest thereon in a second configuration in which the second stand support surface faces upward.

### TECHNICAL FIELD

This disclosure relates to horticultural containers in the form of planters that coordinate with a stand.

### BACKGROUND

The ornamental appearance of planters tends to be of high interest to consumers. Some people like to display planters with their associated potted plants on a stand. Most stands resemble small tables and are often made of a different material than the planter and/or are sold separately from the planter. For instance, the planter may be made from plastic or ceramic and the stand may be made from wood, metal or a combination of materials. Sometimes, the stand material is not suitable for long term use outside where the stand is exposed to precipitation, wide temperature ranges, and long periods of sunlight.

Conventionally, the planter and stand may be displayed in only one arrangement, such as the planter placed on top of an upper surface of the stand. If more than one planter and stand of the same type are used, a variation in height of one of the planters relative to another planter is not readily achieved.

Some stands, such as those made of metal wire, have rings into which a planter is inserted. For these types of stands, the ring tends to support the planter by engaging a sidewall of the planter where the sidewall of the planter has a larger outside diameter than an inside diameter of the ring. Similar to table-type stands, these stand allow the planter to be displayed at a single elevation.

Also, while multiple planters are often stacked together in nested fashion for efficient shipping, stands generally are not made to be stacked and can consume considerable packaging and/or volume when shipped in large quantities.

### SUMMARY

There is a need in the art for an improved planter and stand arrangement that creates a desirable appearance when displayed and that consumes less volume when shipped.

A planter and stand assembly includes a stand having a sidewall surrounding a hollow region and tapered between a first end of the sidewall and a second end of the sidewall, the stand having a first opening at the first end and a second opening at the second end, the first opening larger than the second opening, and the stand having a first stand support surface at the first end and a second stand support surface at the second end; and a planter having a first planter support surface sized to radially overlap with the first stand support surface and rest thereon in a first configuration in which the first stand support surface faces upward and a second planter support surface sized to radially overlap with the second stand support surface and rest thereon in a second configuration in which the second stand support surface faces upward.

### BRIEF DESCRIPTION OF DRAWINGS

FIG. 1 is a perspective view of a representative planter and stand in a first configuration.

FIG. 2 is another perspective view of the representative planter and stand in the first configuration.

FIG. 3 is an elevational view of a cross-section of the representative planter and stand in the first configuration taken through a longitudinal axis thereof.

FIG. 4 is the cross-section of FIG. 3, but shown in perspective.

FIG. 5 is a perspective view of the representative planter and stand in a second configuration.

FIG. 6 is an elevational view of a cross-section of the representative planter and stand in the second configuration taken through a longitudinal axis thereof.

### DETAILED DESCRIPTION

The figures are to scale, but it will be understood that the various views may be enlarged or reduced relative to one another. Also, the dimensions of the planter and/or the stand may be altered (e.g., the planter and/or the stand may be made taller without being made comparatively wider or vice versa, and/or other changes may be made).

Embodiments will be described with reference to the figures, wherein like reference numerals are used to refer to like elements throughout. Features that are described and/or illustrated with respect to one embodiment may be used in the same way or in a similar way in one or more other embodiments and/or in combination with or instead of the features of the other embodiments.

As used herein, the term “nested” refers to one object being placed in or stored at least partially inside another object.

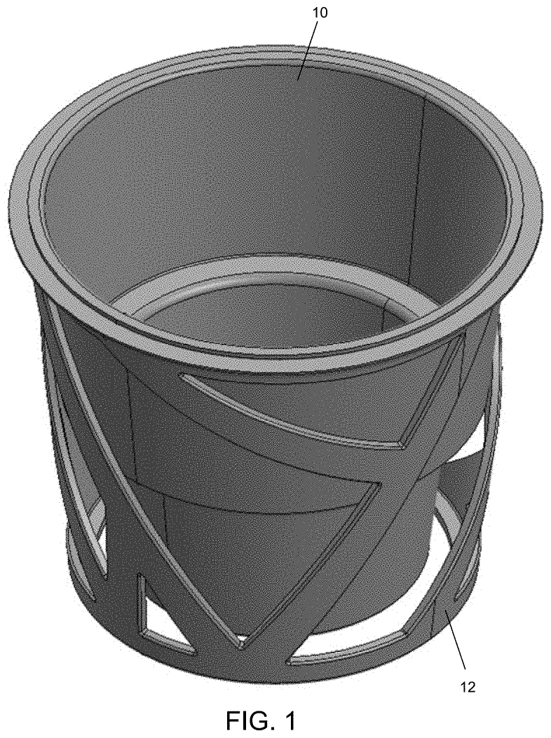

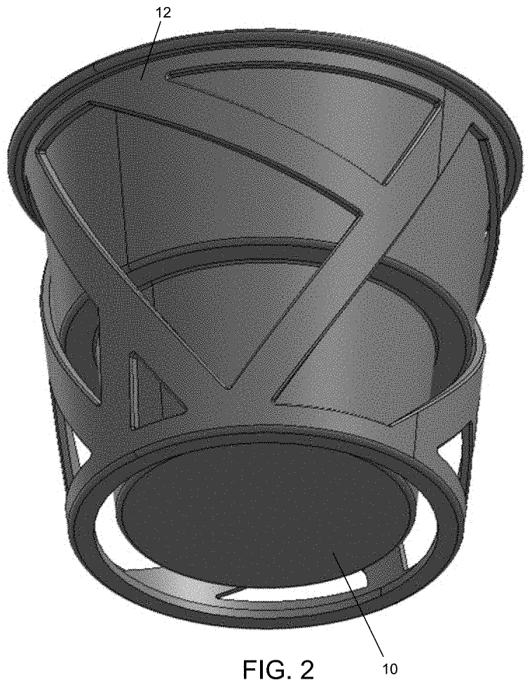

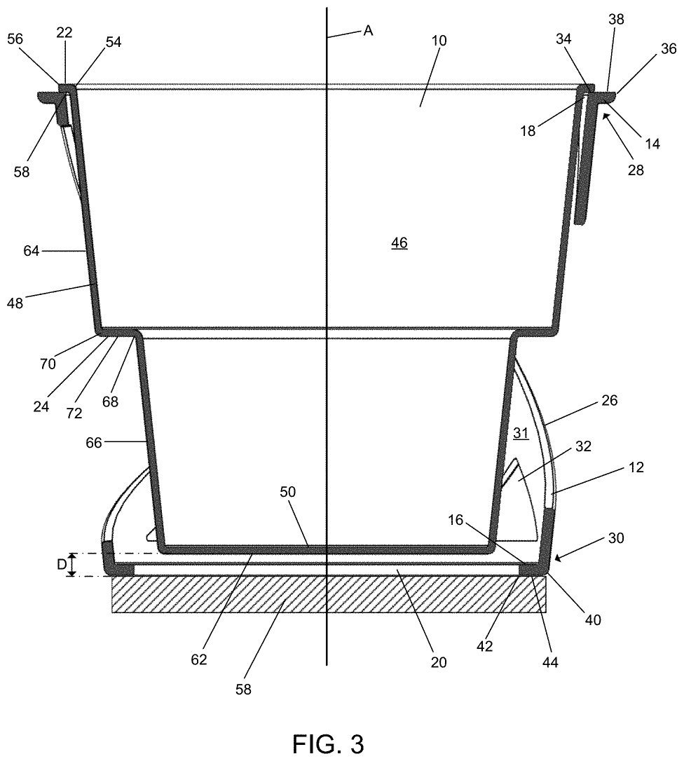

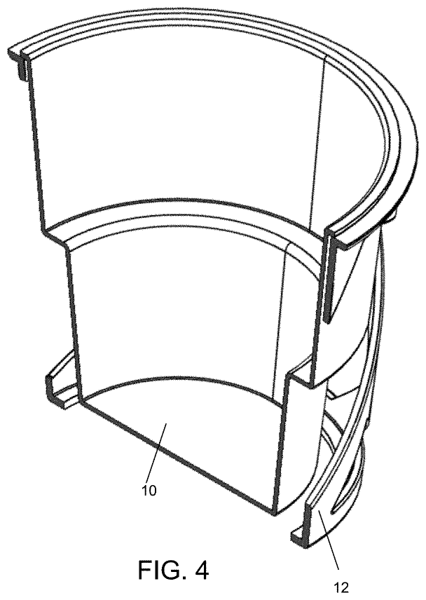

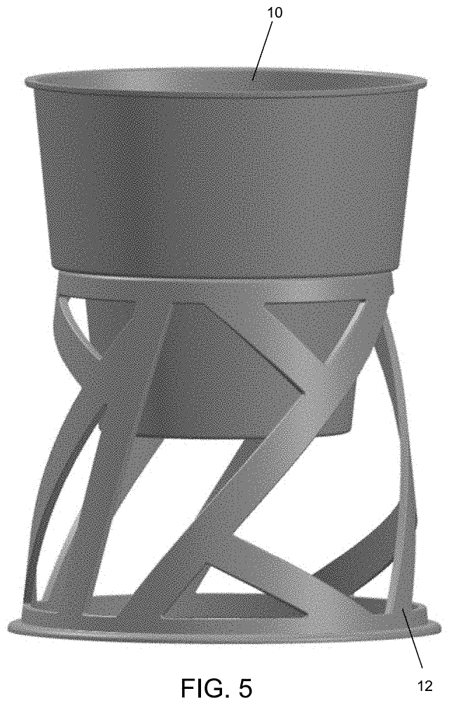

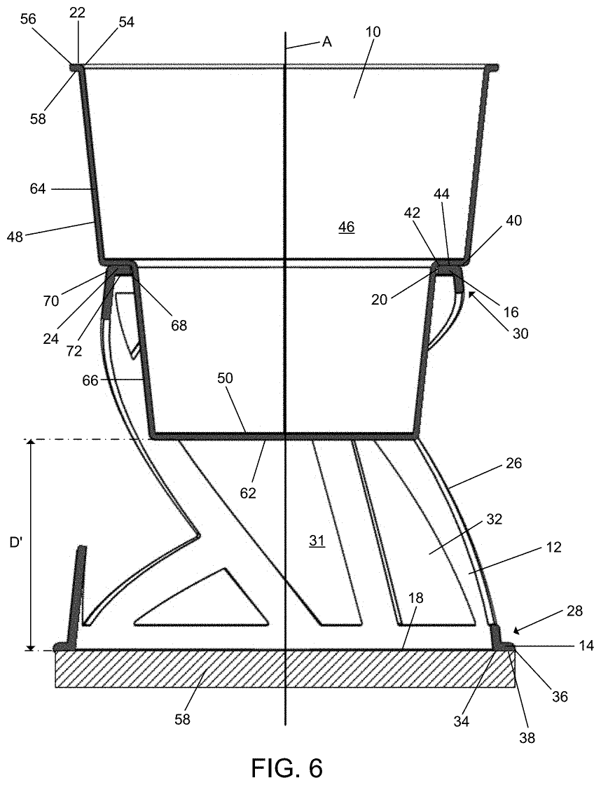

Referring to the figures, illustrated is a planter 10 and a stand 12. The planter 10 and the stand 12 are separate articles that, in one embodiment, have no permanent connection between them. In this embodiment, the planter 10 and the stand 12 easily come apart from one another. FIGS. 1-4 show the planter 10 and the stand 12 in a first configuration relative to one another in which a first rim 14 of the stand 12 supports the planter 10. FIGS. 5-6 show the planter 10 and the stand 12 in a second configuration relative to one another in which a second rim 16 of the stand 12 supports the planter 10. Other configurations or interrelationships between the planter 10 and the stand 12 may be possible.

A size of an opening 18 of the stand 12 surrounded by the first rim 14 is larger than a size of an opening 20 of the stand surrounded by the second rim 16. The first rim 14 of the stand 12 and the opening 18 are sized and shaped to coordinate with the planter 10, including an upper rim 22 of the planter 10. The second rim 16 of the stand 12 and the opening 20 are sized and shaped to coordinate with the planter 10, including a shoulder 24 of the planter 10.

The first rim 14 and the second rim 16 are spaced apart from one another in a longitudinal direction of the stand 12 (i.e., along a longitudinal axis A of the stand 12). In the planter and stand assembly of the first and second configurations, the longitudinal axis A of the stand 12 is shared with the longitudinal axis of the planter 10. Therefore, the longitudinal axes of the stand 12 and of the planter 10 will both be referred to with the same reference letter “A”.

A side wall 26 of the stand 12 extends between the first rim 14 and the second rim 16 with the first rim 14 at a first end 28 of the stand 12 and the second rim 16 at a second end 30 of the stand. The side wall 26 need not extend longitudinally past the first rim 14 and/or the second rim 16. The sidewall 26 tapers as it extends longitudinally from the second end 30 to the first end 28. Thus, the sidewall 26 is radially more distant from the longitudinal axis A at the first end 28 than at the second end 30. The side wall 26 and rims 14, 16 join together to form a generally tubular shape that surrounds a hollow region 31 and is open at both ends 28, 30, and that is wider at the first end 28 than at the second end 30.

In the illustrated embodiment, the side wall 26 has openings 32 to create a decorative appearance to the stand 12 and to consume less material. Also, the side wall 26 has a slightly bowed configuration in as it extends longitudinally from the second end 30 to the first end 28. The openings 32 may be changed relative to those shown or the openings 32 may be omitted so that the side wall 26 is contiguous. The bow in the sidewall 26 also may be omitted so that the side wall 26 extends linearly from the second end 30 the first end 28.

The first rim 14 extends radially outward from the wall 26. For instance, the first rim 14 has a proximal inner edge 34 where the rim 14 joins with the side wall 26 and a distal outer edge 36. The inner edge 34 is radially inward from outer edge 36 so as to form a first stand support surface 38 between the edges 34, 36 and on a side of the first rim 14 longitudinally opposite the sidewall 26.

The second rim 16 extends radially inward from the wall 26. For instance, the second rim 16 has a proximal outer edge 40 where the rim 16 joins with the side wall 26 and a distal inner edge 42. The inner edge 42 is radially inward from outer edge 40 so as to form a second stand support surface 44 between the edges 40, 42 and on a side of the second rim 16 longitudinally opposite the sidewall 26.

The planter 10 forms a chamber 46 for receiving planting medium (not shown), such as soil, and one or more plants (not shown). For this purpose, the planter 10 includes a side wall 48 and a bottom wall 50 that form the chamber 46, which is open at an upper end thereof. The upper rim 22 of the planter 10 is joined to an upper end of the side wall 48. The upper rim 22 extends radially outward from the side wall 48. For instance, the upper rim 22 has a proximal inner edge 54 where the rim 22 joins with the side wall 48 and a distal outer edge 56. The inner edge 54 is radially inward from outer edge 56 so as to form a first planter support surface 58 between the edges 54, 56 and on a lower side of the upper rim 22.

In the first configuration, the second stand support surface 44 sits on and is supported by a substrate 60, such a floor, the ground, a table top, etc. This leaves the first stand supporting surface 38 facing upward. The planter 10 is inserted into the hollow region 31 of the stand 12 until the first planter support surface 58 rests directly on the first stand supporting surface 38. For this purpose, the planter 10 is configured so that the first planter support surface 58 radially overlaps with the first stand supporting surface 38. In the illustrated embodiment, portions of the planter 10 below the upper rim 22 are nested within the stand 12.

In the illustrated embodiment, the stand 12 is longer (taller) than the planter 10 in the longitudinal direction. Therefore, a bottom exterior surface 62 of the planter 10 (e.g., the lowest surface of the planter 10) is spaced above the substrate 60 by a distance D. The distance D may be made very small (e.g., a few millimeters or fractions of an inch) to very large (e.g., measured in meters, feet or yards). The planter 10 and stand 12 may be sized as desired to achieve the desired distance D for various ornamental or functional goals. In one embodiment, the sizes of the planter 10 and stand 12 may be made so that the bottom exterior surface 62 contacts the substrate 60, with or without leaving a gap between the first planter support surface 58 and the first stand supporting surface 38. In some embodiments, the bottom exterior surface 62 is an exterior surface of the bottom wall 50. In other embodiments, the planter 10 may include a saucer or self-watering device connected to or integral with the bottom surface 50 or with another part of the planter 10. In this case, the bottom exterior surface 62 that is spaced above the substrate 60 by the distance D may be part of the saucer or self-watering device.

The sidewall 48 of the planter 10 includes a shoulder 24 longitudinally located between the upper rim 22 and the bottom wall 50. The shoulder 24 divides the sidewall 48 so as to have an upper portion 64 of the side wall 48 and a lower portion 66 of the side wall 48. The shoulder 24 has an inner edge 68 where the shoulder 24 joins with the lower portion 66 of the side wall 48 and an outer edge 70 where the shoulder 24 joins with the upper portion 64 of the side wall 48. The inner edge 68 is radially inward from outer edge 70 so as to form a second planter support surface 72 between the edges 68, 70 and on a lower side of the shoulder 24 (i.e., on the exterior of the planter 10 facing the substrate 58). The upper portion 64 of the side wall 48 tapers radially inward as the upper portion 64 extends from the upper rim 22 to the shoulder 24. The lower portion 66 of the side wall 48 tapers radially inward as the lower portion 66 extends from the shoulder 24 to the bottom wall 50.

In the second configuration, the first stand support surface 38 sits on and is supported by the substrate 60. This leaves the second stand supporting surface 44 facing upward. The planter 10 is inserted into the hollow region 31 of the stand 12 until the second planter support surface 72 rests directly on the second stand supporting surface 44. For this purpose, the planter 10 is configured so that the second planter support surface 72 radially overlaps with the second stand supporting surface 44. In the illustrated embodiment, portions of the planter 10 below the shoulder 24 are nested within the stand 12 and portions of the planter 10 above the shoulder 24 are located above the stand 12.

In the second configuration, the bottom exterior surface 62 is spaced above the substrate 60 by a distance D′, which is greater than the distance D of the first configuration. In the illustrated embodiment, the distance D′ is the distance D plus the longitudinal distance between the first planter support surface 58 and the second planter support surface 72. The planter 10 and stand 12 may be sized as desired to achieve the desired distance D′ for various ornamental or functional goals.

In the illustrated embodiment, the planter 10 and the stand 12 are circular about the longitudinal axis A, and the support surfaces 38, 44, 58, 72 form annular rings. In either configuration, the planter 10 may be placed on the stand 12 in any relative rotational alignment between the planter 10 and the stand 12. Other shapes for the planter 10 and stand 12 are possible, such as oval, triangular, square, rectangular, other polygons, and non-uniform shapes. Shapes of the planter 10 about the longitudinal axis A other than round will tend to require rotational alignment of the planter 10 and the stand 12.

The rims 14, 16, 22 and/or shoulder 24 may be configured in manner other than as shown, which will result in corresponding changes to the support surfaces 38, 44, 58, 72. For instance, the support surfaces 38, 44, 58, 72 need not be planar and/or need not be contiguous around the longitudinal axis A. Other arrangements that may form the support surfaces 38, 44, 58, 72 include, but are not limited to, lips, detents, vertical ribs, shoulders, lugs, and projections. In another embodiment, the first rim 14 and/or the second rim 16 may be omitted so that opposing end surfaces of the sidewall form the first stand support surface 38 and/or the second stand support surface 44.

The planter 10 and the stand 12 may be manufactured separately. In one embodiment, the planter 10 and the stand 12 may be made by injection molding from plastic material, or by another appropriate technique and/or from another material. Multiple planters 10 may be stacked together in nested fashion for shipping. Similarly, multiple stands 12 may be stacked together in nested fashion for shipping. In these embodiments, the planters 10 are configured to nest together by one planter 10 nesting within the cavity 46 of an adjacent planter 10. Similarly, the stands 12 are configured to nest together by one stand 12 nesting within the hollow region 31 of an adjacent stand 12. For instance, a first stand 12 may be placed with the first stand support surface 38 facing upward and a second stand 12 may be inserted into the hollow region 31 of the first stand 12 until the second stand support surface 44 of the second stand rests on the upper side of the second rim 16 of the first stand 10 and/or the underside of the first rim 14 of the second stand 12 rests on the first stand support surface 38 of the first stand 12. This arrangement may be repeated until a desired number of stands 12 are stacked and nested together. Shipping one or more stacks of the planters 10 and one or more stacks of the stands 12 reduces overall volume as comparted to the volume needed to ship planters 10 that are nested with respective stands 12.

Although certain embodiments have been shown and described, it is understood that equivalents and modifications falling within the scope of the appended claims will occur to others who are skilled in the art upon the reading and understanding of this specification.

What is claimed is:

1. A planter and stand assembly, comprising:
a stand having a sidewall surrounding a hollow region and tapered between a first end of the sidewall and a second end of the sidewall, the stand having a first opening at the first end and a second opening at the second end, the first opening larger than the second opening, and the stand having a first stand support surface at the first end and a second stand support surface at the second end; and
a planter having a first planter support surface sized to radially overlap with the first stand support surface and rest thereon in a first configuration in which the first stand support surface faces upward and a second planter support surface sized to radially overlap with the second stand support surface and rest thereon in a second configuration in which the second stand support surface faces upward.

2. The planter and stand assembly of claim 1, wherein at least a portion of the planter nests in the stand in each of the first and second configurations.

3. The planter and stand assembly of claim 1, wherein the first planter support surface is part of a rim protruding from a sidewall of the planter.

4. The planter and stand assembly of claim 3, wherein a portion of the planter below the rim nests in the stand in the first configuration.

5. The planter and stand assembly of claim 1, wherein the second planter support surface is a shoulder formed in a sidewall of the planter between upper and lower ends of the planter.

6. The planter and stand assembly of claim 5, wherein a portion of the planter below the shoulder nests in the stand in the second configuration.

7. The planter and stand assembly of claim 1, wherein the first stand support surface is part of a rim radially protruding outward from the sidewall of the stand.

8. The planter and stand assembly of claim 1, wherein the second stand support surface is part of a rim radially protruding inward from the sidewall of the stand.

9. The planter and stand assembly of claim 1, wherein the sidewall of the stand comprises one or more openings located between the first and second ends of the stand.

10. The planter and stand assembly of claim 1, wherein a bottom exterior surface of the planter is spaced above a surface that supports the stand in the first and second configurations, an elevation of the bottom exterior surface in the first configuration less than an elevation of the bottom exterior surface in the second configuration.
